(19) United States
(12) Patent Application Publication
(10) Pub. No.: US 2018/0259081 A1
(43) Pub. Date: Sep. 13, 2018

(54) VALVE STRUCTURE, AND HYDRAULIC DEVICE, FLUID MACHINE, AND MACHINE, EACH HAVING SAME

(71) Applicant: HITACHI, LTD., Tokyo (JP)

(72) Inventors: U OH, Tokyo (JP); Katsutoshi KOBAYASHI, Tokyo (JP)

(73) Assignee: HITACHI, LTD., Tokyo (JP)

(21) Appl. No.: 15/761,279

(22) PCT Filed: Sep. 12, 2016
(86) PCT No.: PCT/JP2016/076825

§ 371 Date: Mar. 19, 2018

(30) Foreign Application Priority Data
Nov. 6, 2015 (JP) 2015-218190

(51) Int. Cl. F16K 17/04; F16K 1/34; F16K 47/02; F15D 1/00

(52) U.S. Cl. CPC F16K 17/0433; F15D 1/0015; F16K 47/02; F16K 1/34

(57) ABSTRACT

Provided is a valve structure capable of suppressing the vibration of a valve body. The valve structure includes a valve body and a valve seat. The valve seat has a flow path of a fluid. The flow path opens and closes. A groove surrounding a central axis of the flow path is formed in a flow path wall surface downstream of a contact section between the valve body and the valve seat.

### TECHNICAL FIELD

The present invention relates to a valve structure and to a hydraulic device, a fluid machine, and a machine that have the valve structure.

### BACKGROUND ART

Hydraulic excavators, wheel loaders, and other construction machines using hydraulic pressure employ a plurality of hydraulic actuators in order to perform various tasks. These actuators are coupled to pumps that supply pressurized fluid to chambers in the actuators. Basically, hydraulic control valves are disposed between the pumps and actuators to control the flow rate and flow direction of liquids supplied from the pumps.

In a hydraulic circuit in which a plurality of actuators are controlled by a common pump, unexpected pressure fluctuations may occur during actuator operations. Such pressure fluctuations may reduce the operating efficiency of the actuators. Further, if an unexpectedly high pressure is generated in the hydraulic circuit, such pressure fluctuations may make hydraulic circuit parts defective.

A pressure control valve is used as a part that reduces unexpected pressure fluctuations occurring in the hydraulic circuit. A poppet valve is used as a typical example of the pressure control valve. The poppet valve is advantageous, for example, in that it includes a small number of parts and exhibits good pressure response. However, the poppet valve is prone to vibrate. Therefore, efforts are being made to suppress the vibration of the poppet valve by forming an appropriate hydraulic circuit and by shaping the poppet valve as appropriate.

For example, the vibration of a valve body was suppressed in the past as described in Patent Literature 1 by providing a downstream lateral surface of a valve seat with a semispherical concave or a protrusion to enhance the effect of boosting a flow in the vicinity of a wall surface along a valve seat surface to a turbulent flow, and by thinning a boundary layer near the wall surface to prevent the flow from separating from the valve seat surface.

### CITATION LIST

### Patent Literature

Patent Literature 1: Japanese Patent Application Laid-Open No. H09(1997)-170668

### SUMMARY OF INVENTION

Problems to be Resolved by the Invention

When the shape described in Patent Literature 1 is employed, a sufficient effect is not produced because a vortex noise is generated due to a vortex formed in the vicinity of a downstream wall surface of a valve seat and because a noise is generated due to the formation and collapse of a cavitation, which is likely to be formed in a region having convex and concave surfaces.

The above type of valve is advantageous in that it includes a small number of parts and exhibits good pressure response. However, the problem is that the above type of valve is prone to vibrate.

An object of the present invention is to provide a valve structure that suppresses the vibration of a valve body.

### Means of Solving the Problems

A valve structure according to the present invention includes a valve body and a valve seat. The valve seat has a flow path of a fluid. The flow path opens and closes. A groove surrounding a central axis of the flow path is formed in a flow path wall surface downstream of a contact section between the valve body and the valve seat.

### Advantageous Effects of the Invention

The present invention reduces the amount of vortex generation and suppresses fluctuations in fluid force exerted on a valve body. This makes it possible to suppress the vibration phenomenon of a valve, decrease the force generated upon collision between the valve body and a valve seat, reduce the frequency of cavitation formation, and prevent damage to the valve. As a result, the present invention provides a highly reliable valve.

### BRIEF DESCRIPTION OF DRAWINGS

FIG. 1A is a schematic longitudinal cross-sectional view illustrating a valve structure according to a first embodiment.

FIG. 1B is a schematic longitudinal cross-sectional view illustrating a part of the flow line of a fluid in the valve structure shown in FIG. 1A.

FIG. 2 is a graph illustrating the frequency analysis results of vorticity and fluid force.

FIG. 3 is a graph illustrating the effects of suppressing valve body vibrations.

FIG. 4 is a schematic longitudinal cross-sectional view illustrating the valve structure according to a second embodiment.

FIG. 5 is a schematic longitudinal cross-sectional view illustrating the valve structure according to a third embodiment.

FIG. 6 is a schematic side view illustrating a hydraulic excavator including an actuator having the valve structure according to the present invention.

FIG. 7 is a schematic diagram illustrating a configuration of a boom cylinder drive section of the hydraulic excavator shown in FIG. 6.

FIG. 8 is a schematic longitudinal cross-sectional view illustrating a conventional valve structure.

### DESCRIPTION OF EMBODIMENTS

Embodiments of the present invention will now be described with reference to the accompanying drawings.

### First Embodiment

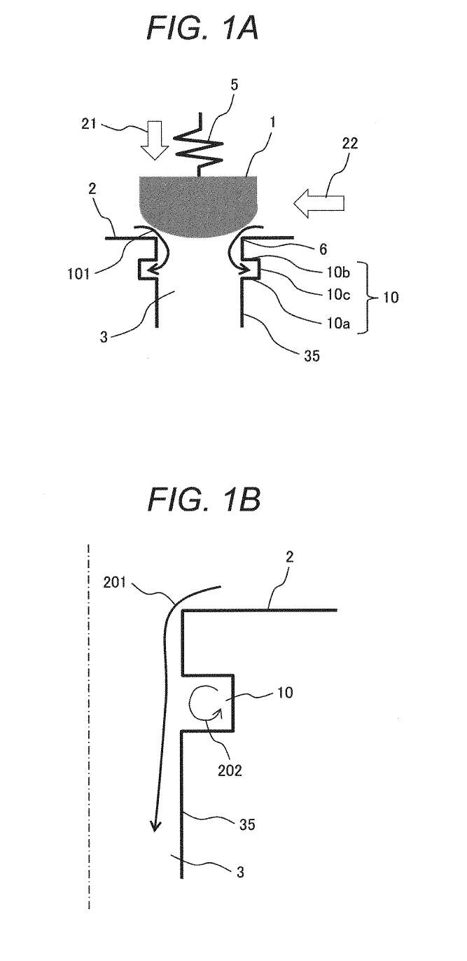

FIG. 1A is a schematic longitudinal cross-sectional view illustrating a valve structure according to a first embodiment.

Referring to FIG. 1A, essential elements of the valve structure are a valve body 1, a valve seat 2, and a spring 5. The valve seat 2 includes a flow path 3. While a valve is closed, the valve body 1 and the valve seat 2 are in contact with each other at a contact section 6. FIG. 1A shows a state where the valve is open. A groove 10 is formed along the entire periphery of a flow path wall 35 downstream of the contact section 6. In the first embodiment, the flow path 3 is shaped like a circular hole when viewed cross-sectionally, and the groove 10 is annular in shape. The cross-sectional shape of the groove 10 is rectangular as viewed in FIG. 1A. The wall surface of the groove 10 is formed of a lower groove surface 10a, an upper groove surface 10b, and a lateral groove surface 10c. A flow line 101 depicts a fluid that flows into the groove 10 through the flow path 3 due to a pressure difference.

The cross section of the flow path 3 is not limited to a circular shape, and may be, for example, an oval, rectangular, or polygonal shape. Further, the cross section of the groove 10 is not limited to a rectangular shape, and may be, for example, a semicircular or triangular shape. Furthermore, the groove 10 is preferably continuous, but may be shaped like a discontinuous, broken line. If the groove 10 is shaped like a discontinuous, broken line, it is preferable that continuous portions of the broke-line groove be at least 80 percent of the whole length of a groove path. Moreover, the number of discontinuous portions is not particularly limited, but it is preferable that the length of the discontinuous portions be minimized.

The behavior of the valve body 1 determined by the balance between a spring force 21, which is exerted by spring 5 to press the valve body 1 against the valve seat 2, and a fluid force 22, which is exerted by an incoming liquid in the direction of opening the valve body 1. When a fluid comes in through an inlet and the fluid force 22 exerted on the valve body 1 becomes greater than the spring force 21, the valve body 1 moves in the opening direction. When the fluid force 22 exerted on the valve body 1 becomes smaller than the spring force 21, the valve body 1 moves in the closing direction. As the valve body 1 and the contact section 6 form a throat section, a vortex is likely to form at an outlet of the contact section 6.

Consequently, if the valve body 1 and the contact section 6 of the flow path 3 repeatedly collide with each other, a vortex repeatedly forms and disappears downstream of the contact section 6.

The lower groove surface 10a, which is one of the wall surfaces of the groove 10, is provided to guide a vortex to the groove 10 and confine the vortex into the groove 10. The upper groove surface 10b is provided to prevent a vortex from flowing back and affecting the behavior of the valve body 1. Due to the formation and disappearance of a vortex, significant pressure fluctuations occur downstream of the contact section 6. The lateral groove surface 10c is provided to reduce such pressure fluctuations.

As the groove 10 is provided, the amount of vortex formed downstream of the contact section 6 decreases to stabilize the fluid force 22 exerted on the valve body 1.

FIG. 1B illustrates a part of the flow line of a fluid the valve structure shown in FIG. 1A. A one-dot chain line in FIG. 1B represents the center line (central axis) of the flow path 3.

As illustrated in FIG. 1B, when a fluid flows inward, a vortex 202 forms in the groove 10. The flow line 201 of a laminar flow in the flow path 3 then comes close to the flow path wall 35. That is to say, the flow path cross-sectional area of a laminar flow region in the flow path 3 is enlarged.

FIG. 8 illustrates a part of the flow line of a fluid in a conventional valve structure.

Referring to FIG. 8, no groove is formed in the flow path wall 35. Therefore, a vortex 302 forms near the flow path wall 35 so that the flow line 301 of a laminar flow is shifted toward the center of the flow path 3. In this manner, the vortex 302 forms in a larger region to increase the amount of vortex 302. Thus, greater pressure fluctuations tend to occur in the flow path 3. That is to say, the flow path cross-sectional area of the laminar flow region in the flow path 3 decreases to destabilize the flow and pressure.

FIG. 2 illustrates the frequency analysis results of a fluid force exerted on the valve body and a vortex formed downstream of the contact section between the valve body and the valve seat in a case where no groove is formed. The horizontal axis represents frequency, and the vertical axis represents amplitude.

FIG. 2 indicates that fluctuation components of the fluid force exerted on the valve body coincide with fluctuation components of vortex formation and disappearance. It is therefore conceivable that a vortex formed downstream of the contact section is one of the factors increasing the vibration of the valve body.

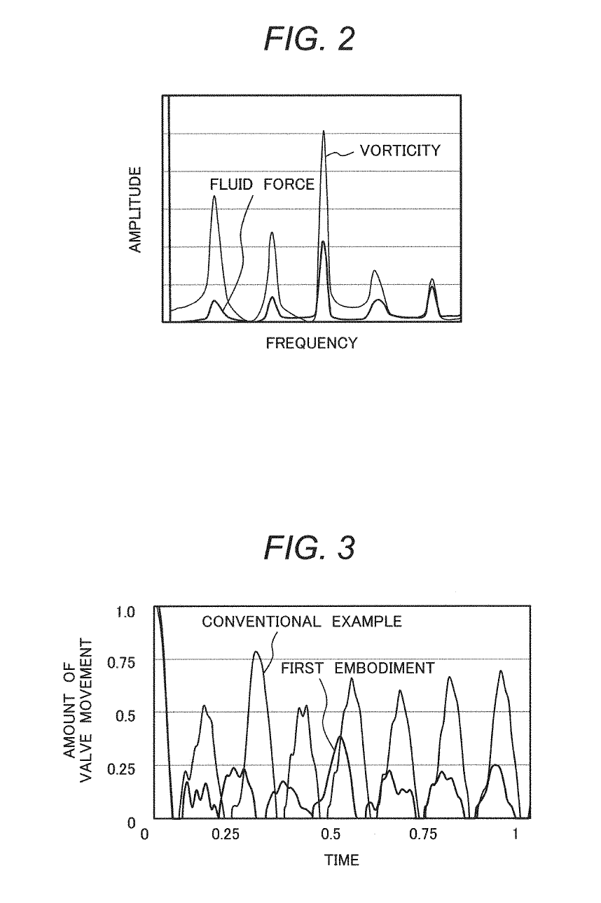

FIG. 3 is a graph illustrating the effects of suppressing valve body vibrations. The horizontal axis represents time, and the vertical axis represents the amount of valve movement.

Referring to FIG. 3, the maximum amount of valve movement is large in the case of a conventional example having no groove. Meanwhile, in the case of the first embodiment having the groove, the maximum amount of valve movement is small. This indicates that valve body vibration is smaller in the first embodiment than in the conventional example.

The annular structure of the groove 10 according to the present invention is preferably parallel to a plane orthogonal to the central axis of the flow path. Alternatively, however, the annular structure of the groove 10 may be at a predetermined angle from such a plane. The predetermined angle is preferably 45° or less, and more preferably 30° or less. It is particularly preferable that the predetermined angle be 15° or less.

### Second Embodiment

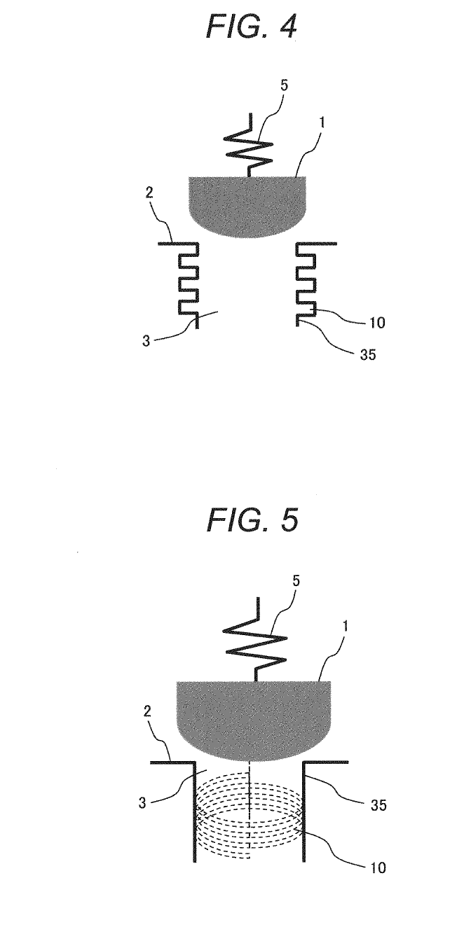

FIG. 4 illustrates the valve structure according to a second embodiment.

The second embodiment has the same basic configuration as the first embodiment. The second embodiment differs from the first embodiment in that two or more grooves 10 are formed along the entire periphery of the flow path wall 35 downstream of the contact section 6.

As the above-described structure is employed, a vortex unprocessable by an upstream groove 10 can be guided to a downstream groove 10.

### Third Embodiment

FIG. 5 illustrates the valve structure according to a third embodiment.

The third embodiment has the same basic configuration as the first embodiment. The third embodiment differs from the first embodiment in that a spiral groove 10 is formed along the entire periphery of the flow path wall 35 downstream of the contact section 6.

In FIG. 5, the groove 10 in the flow path wall 35 is deformed in a partial perspective view in order to clearly indicate that the groove 10 is spirally formed.

The above-described spiral groove 10 acts on a fluid in the same manner as in the first and second embodiments, guides a vortex into the groove 10, and suppresses the occurrence of vortex-induced vibration.

The spiral structure of the groove 10 according to the present invention is preferably parallel to a plane orthogonal to the central axis of the flow path. Alternatively, however, the spiral structure of the groove 10 may be at a predetermined angle from such a plane. The predetermined angle (spiral angle) is preferably 45° or less, and more preferably 30° or less. It is particularly preferable that the predetermined angle be 15° or less.

A feature common to the first to third embodiments is that the central axis of the flow path is surrounded by the groove 10.

A hydraulic device having the above-described valve structure and a machine having such a hydraulic device will now be described.

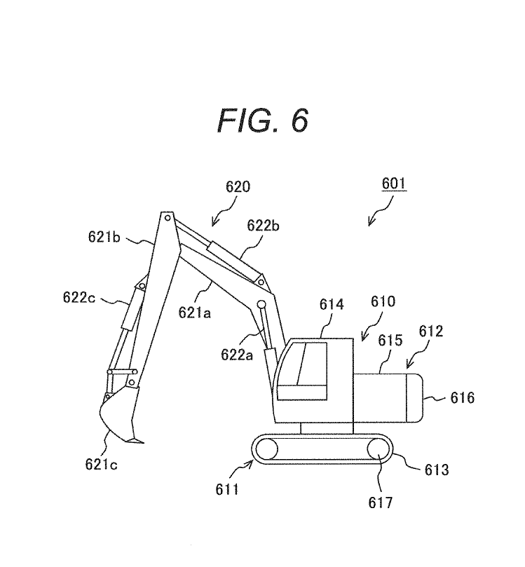

FIG. 6 illustrates a hydraulic excavator (construction machine) including an actuator having the valve structure according to the present invention.

Referring to FIG. 6, the hydraulic excavator 601 includes a vehicle body 610, a work machine 620, and a crawler 611. The vehicle body 610 includes a vehicle main body 612 and a cab 614. The vehicle main body 612 includes a motive power chamber 615 and a counterweight 616.

The work machine 620 includes a boom 621a, an arm 621b, and a bucket 621c. The boom 621a is a driven part. The boom 621a, the arm 621b, and the bucket 621c are respectively driven by their actuators, namely, a boom cylinder 622a, an arm cylinder 622b, and a bucket cylinder 622c.

The crawler 611 includes a crawler belt 613 and a traction motor 617. The traction motor 617 rotates to drive the crawler belt 613, thereby causing the crawler 611 to travel.

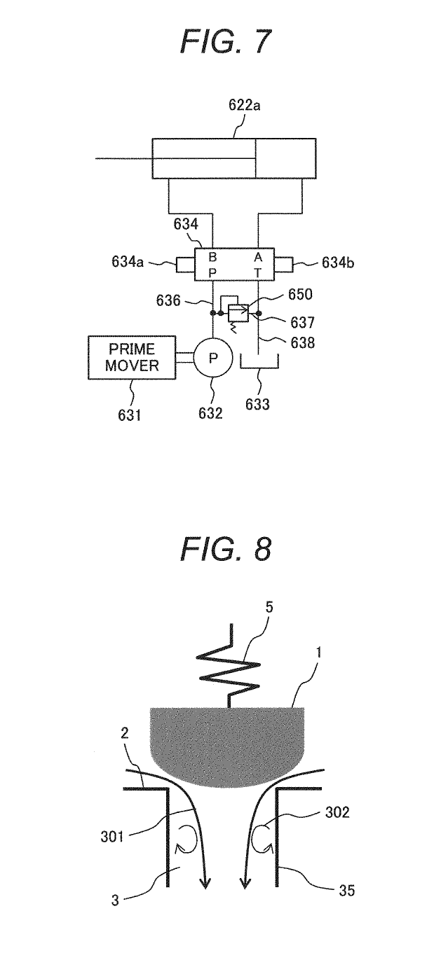

FIG. 7 illustrates a drive section of the boom cylinder, which is one of the actuators for the hydraulic excavator shown in FIG. 6.

Referring to FIG. 7, the boom cylinder 622a is connected to conduits 636, 638 for delivering hydraulic pressure. The hydraulic pressure is adjusted, for example, by a prime mover 631, a hydraulic pump 632, a control valve 634, and relief valve 650. The control valve 634 includes two valves 634a, 634b. The pressure of oil (incompressible fluid) delivered from the hydraulic pump 632, which is driven by the prime mover 631, is transmitted to the boom cylinder 622a through the conduit 636. When the relief valve 650 opens, the oil flows into a conduit 637 and then flows into the conduit 638 from the conduit 636. The oil is eventually stored in a tank 633.

As described above, the valve structure according to the present invention is applied to a hydraulic device (actuator), and reduces noise generated from a machine using the motive power of the actuator.

The valve structure according to the present invention is applicable not only to hydraulic devices, but also to fluid transport pumps and other fluid machines. Further, the valve structure according to the present invention is also applicable to automobiles and other machines that include such a fluid machine and use a fluid as a fuel.

Machines generating motive power by using a hydraulic device having a valve structure may be, for example, robots and construction machines such as hydraulic excavators and bulldozers.

Fluid machines having a valve structure may be, for example, automotive fuel pumps.

Machines including a pump having a valve structure or other fluid machine capable of transporting a fluid may be, for example, automobiles.

In this document, the term “hydraulic device” denotes a device that transmits a pressure by using oil, which is a liquid. The term “fluid machine capable of transporting a fluid” denotes an apparatus that moves downstream a fluid such as a fuel used, for example, by an engine. The term “machine” denotes an apparatus that incorporates a device such as a hydraulic device or a fluid machine.

When the description is given with reference to FIGS. 6 and 7, a hydraulic excavator (construction machine) having a hydraulic device is cited as an example. However, the machine according to the present invention is not limited to a hydraulic excavator. Further, construction machines and other mobile machines include not only a hydraulic device but also a fuel pump, which acts as a fluid machine capable of transporting gasoline, light oil, heavy oil, or other liquid fuel. Therefore, the machine according to the present invention may include a plurality of different devices having a valve structure, and an appropriate valve structure is applied to each of these devices.

### LIST OF REFERENCE SIGNS

1: Valve body,
2: Valve seat,
3: Flow path,
5: Spring,
6: Contact section,
10: Groove,
10a: Lower groove surface,
10b: Upper groove surface,
10c: Lateral groove surface,
35: Flow path wall,
101, 201, 301: Flow line,
202, 302: Vortex.

1. A valve structure comprising:
a valve body; and
a valve seat which has a flow path of a fluid, the flow path being adapted to open and close;
wherein a groove which surrounds a central axis of the flow path is formed in a flow path wall surface downstream of a contact section between the valve body and the valve seat.

2. The valve structure according to claim 1, wherein the groove has an annular or spiral shape.

3. The valve structure according to claim 1, wherein the groove has a continuous structure.

4. The valve structure according to any one of claim 1, wherein the groove includes a plurality of grooves.

5. A hydraulic device that has the valve structure according to any one of claim 1.

6. A machine that has the hydraulic device according to claim 5 and generates motive power.

7. A fluid machine which has the valve structure according to any one of claim 1 and transports the fluid.

8. A machine that has the fluid machine according to claim 7 and uses the fluid as a fuel.
